(19) United States
(12) Patent Application Publication
(10) Pub. No.: US 2008/0212573 A1
(43) Pub. Date: Sep. 4, 2008

(54) Enhanced Call Detail Record with Information Provided by User

(76) Inventors: Rogier Noldus, Goirle (NL); Jos Den Hartog, Capelle a/d Ijssel (NL)

Correspondence Address: ERICSSON INC., 6300 LEGACY DRIVE, M/S EVR 1-C-11, PLANO, TX, 75024, US

(21) Appl. No.: 11/915,906

(22) PCT Filed: May 31, 2005
(86) PCT No.: PCT/EP2005/005964

§ 371 Date: Nov. 29, 2007

(51) Int. Cl. H04B 1/06

(52) U.S. Cl. 370/355

(57) ABSTRACT

The present invention is related to a method of handling a call between a plurality of users via a circuit switched telecommunications network. Each of said plurality of users comprises a terminal connected to say network for establishing said call. A call between said users are established, and call detail information for said call is registered on said network. At least one of said users provides user information to said network after said call has been established, and said user information comprises identification data for associating said user information with said call detail information. The invention further provides a terminal unit for use with the method of the present invention.

### FIELD OF THE INVENTION

The invention relates to a method of handling a call between a plurality of users via a circuit switched telecommunications network, wherein each of said plurality of users comprises a terminal connected to said network for establishing said call, wherein said call between said users is established by at least one of said users providing terminal identification data of a terminal of at least one other of said users, and wherein call detail information for said call is registered on said network.

The invention further relates to a communication terminal device for use with a method as described above in a telecommunications system for handling a call between a plurality of users via a circuit switched telecommunications network, comprising means for connecting to said circuit switched telecommunications network, and means for establishing said call.

### BACKGROUND OF THE INVENTION

In a conventional telecommunication network, such as a conventional voice type telecommunications network, upon detection of a telephone call, a call detail record (CDR) is created which tracks the usage of services offered by the telecommunication carrier and records various details associated with the call. Typically, the call detail record includes, for example, such items as the called number, the calling number, the date, the time, the duration of the call and other information relating to the call.

This information is used in the telecommunications network for a number of purposes. Amongst others, the information is used for traffic analysis and forecasting, capacity management and similar purposes, but it's primary function may well be billing of services to customers. The information in the call detail records directly enables calculation of the costs of services (in the form of network usage) of each customer over a certain period of time, and this information is used for establishing an invoice for the telecommunications services rendered.

A disadvantage of this method of providing invoicing, is that the call detail record merely contains information that can be acquired from the various network elements, such as switches, present in the circuit switched telecommunications network. The CDR thus contains information about calling and called parties, connected number, switches involved for establishing a call, call duration, call type, etcetera. A customer receives a telephone bill for e.g. a total number of phone calls and the total duration of calls specified into local calls, long distance calls, and international calls, optionally even specified providing a list of all telephone calls made over the period of interest.

It is increasingly important for lawyers, consultants, employees, etc. to properly document phone usage for accounting purposes and generating the individual bills for time spent on the phone. Aforementioned persons who wants to invoice working hours (and minutes) to the appropriate customer and the appropriate project, can add user information to related call detail records resulting in a detailed telephone bill and use this detailed telephone bill to create their own bills.

From the invoice received from a telecommunications provider, it is difficult to establish this information. One may analyse the telephone bill and compare it to a list with contacting details of customers to establish which customer is called by which employee or lawyer, and what the duration of each call was. However, this is cumbersome and only partly satisfactory, since from this information it can still not be established what the purpose of the call was, and in addition, registering all telephone numbers used for each customer requires an often almost undoable effort. Moreover, costs of telephone calls made for a customer, but not to a customer, or costs of telephone calls to a certain customer but for different projects, cannot be traced using this method.

### SUMMARY OF THE INVENTION

It is an object of the present invention to provide an improved way of handling calls between a plurality of users via a circuit switched telecommunications network, in particular taking into account the problems mentioned above with respect to the prior art.

It is another object of the present invention to enable providing customer dependent invoicing of telecommunications services, wherein requirements of customers are taken into account on an individual basis.

These and other objects of the present invention are achieved in that there is provided a method of handling a call between a plurality of users via a circuit switched telecommunications network, wherein each of said plurality of users comprises a terminal connected to said network for establishing said call, wherein said call between said users is established by at least one of said users providing terminal identification data of a terminal of at least one other of said users, and wherein call detail information for said call is registered on said network, characterized in that, at least one of said users provides user information for said network comprising further identification data for associating said user information with said call detail information.

The method of the present invention as described above provides a means for adding information to the call detail record by a customer or a user of a telecommunication system, which can later on be used for numerous purposes, amongst which specification of the telephone bill up to the user requirements. It is in particular noted that this information may comprise information required for costs tracking by the user of the telecommunication system, specified for the user's own customers. Note therefore, that the user information may comprise according to an embodiment thereof, additional information such as a project account number, a hyperlink to a user document, a user's database, a web page, a program, etc. such that the information on the telephone bill can be linked to a certain activity within a company and can be used for billing purposes by the user of the telecommunication system itself.

In particular it is noted that the inclusion of identification data enables associating the user information with the call detail record of the call involved.

Various means of implementation are possible for the invention described. It is noted that, according to an embodiment of the invention, the user information for the circuit switched telecommunication network is provided via the terminal of the at least one user. It is in particular intended that during or after the call, user add the desired user information by providing it as an input on its terminal (e.g. using a keypad or other input means of the terminal) and associates this information the call made. This last part, associating the user information with the call made, may be performed automatically by the terminal, e.g. by associating the user information the last call made using that terminal or by associating the user information with an ongoing call made from or to the terminal. This provides a straightforward and easy manner of implementation of the invention, to the comfort and use by the at least one user.

According to another embodiment, the user information for the circuit switched telecommunication network is provided using a further telecommunication network. It is thereby noted that in accordance with this embodiment, it may be possible for said user to add the required user information in a message sent through another telecommunication network, such as an packet switched network (e.g. internet) via the same or an additional terminal.

It is however noted that the invention may also be implemented by providing the user information directly or indirectly to said circuit switched telecommunications network. The protocols that may be used for this implementation comprise the use of unstructured supplementary service data (USSD), user-to-user signalling (UUS), session initiation protocol (SIP), short messaging service (SMS), multimedia messaging service (MMS) (in case photographs are to be included) or any other suitable protocol.

If a further network is used, it is noted that during a telephone call, a user may input user information on his personal computer linked to the internet, including e.g. the present time of the day and the identification number of the terminal on the circuit switched telecommunication network on which the call is made. This user information may be included in a message or any other data format, optionally involving an application running on a personal computer, and may then be forwarded from the personal computer, via the internet to a network node or database, or any other network element involved on the circuit switched telecommunication network, which then links the user information to the associated call detail record.

According to another embodiment of the invention, the terminal from which the user makes (or receives) his call, may be connected to both the involved circuit switched telecommunication network, and said further telecommunication network. In that case, the information may be inputted by the user on the terminal used for making the call, while the user information for the circuit switched network is sent via said further telecommunication network. In this embodiment, use may be made of dual transfer mode communication devices, which enable connecting the communication device to both a circuit switched and a packet switched telecommunication network.

Said terminal of said at least one user may be at least of a group comprising a private switching device, a telephone, a computer system, a terminal on a local area network or any other terminal. Where said terminal comprises private switching device, said private switching device may be connected to at least one of a group comprising a telephone, a computer or a local area network.

In accordance with an embodiment with the present invention, said call is established with said at least one user via a first communication channel between said terminal of said user and said circuit switched telecommunication network, and said user information for said circuit switched telecommunication network is provided using a second communication channel between said at least one user and said circuit switched telecommunication network.

It is noted that communication through a connection between the terminal and the circuit switched telecommunication network may take place on different levels, meaning that the information provided by the user which is to be associated with the call detail record in accordance with the invention, may be sent onto the circuit switched telecommunication network over a same connection such that no interference will occur between the voice signal of the call made and the user information sent via the same connection to the circuit switched telecommunication network.

In particular, this may be implemented by making use of a signalling channel on the connection between the terminal and the circuit switched telecommunication network, such as the D-channel of an integrated services digital network line (ISDN-line). It will be appreciated by the person skilled in the art, instead of using the ISDN D-channel, also the B0-channel or B1-channel of the ISDN-line may be used where the voice call is taking place on another of the ISDN-channels available.

It is however noted, that the invention may be applied to at least one type of circuit switched network of a group comprising an integrated services digital network (ISDN), a global system for mobile communications (GSM) network, a universal mobile telecommunications system (UMTS) network, a time division multiple access (TDMA) network and a code division multiple access (CDMA) network.

In accordance with an embodiment of the present invention, the call is established via at least one network node registering said call detail information, and said user information to said network node. It is recalled that the user information may not be sent directly to said network node, but may involve the use of said further telecommunication network, or any other intermediate network nodes required for reaching the desired network node registering the call detail information. Also, the call detail information may not be registered on the network node involved in the establishment of the call itself. The above will however be appreciated by the persons skilled in the art of telecommunications.

In accordance with another embodiment of the invention, the call detail information is called in a call detail database. Such a database may for example be queried on a regular basis for billing purposes by the telecommunications provider.

According to another embodiment, the user information is stored in a user information database.

A part from a call detail database described above, the additional user information provided by the user which is associated with call detail information or call detail records, may be stored in a separate database which may be queried automatically together with querying the call detail database.

In accordance with another embodiment of the present invention, the call detail information is comprised in a call detail record, and the user information is added tot the call detail record after associating user information with said call detail information. In this embodiment, the user information and the call detail information are merged together in a call detail record, and may be stored in the call detail database.

In accordance with another embodiment of the present invention said identification data comprises at least one of a group comprising data for identifying one of said plurality of users, international mobile subscriber identity (IMSI) number and associated counter that identifies the call. This information has proven to be efficient for associating the user information with the call detail information of the call involved.

According to another embodiment, the user information associated to the call detail record is used for specifying a telephone bill. This provides the advantage that the user of the circuit switched telecommunication network may directly linked each call to a specific purpose and may base his own invoicing on this information.

In accordance with another embodiment of the present invention the user information comprises at least one of a group comprising a project account number, a hyperlink to the user document, a users database, a web page or a program.

In accordance with a second aspect of the invention, there is provided a communication terminal device for use with a method according any of the previous claims in a telecommunications system for handling a call between a plurality of users via a circuit switched telecommunications network, comprising means for connecting to said circuit switched telecommunications network, and means for establishing said call by providing terminal identification data of at least one further terminal to said network, characterized in that, said communications terminal device comprises means for providing user information for said circuit switched telecommunications network, comprising identification data for associating said user information with call detail information of said call registered on said circuit switched telecommunications network.

The communication terminal device described above may be a dual transfer mode (DTM) terminal device.

The present invention will now be further elucidated by a description and drawings refer to a preferred embodiment thereof. The invention is not limited to the embodiments disclosed, which are provided for explanatory purposes only, however the scope of the invention is only limited by the appended claims.

### BRIEF DESCRIPTION OF THE DRAWINGS

FIG. 1 schematically illustrates a circuit switched telecommunication network adapted for performing the method of the present invention.

FIG. 2 schematically illustrates the method steps of the present invention.

### DETAILED DESCRIPTION OF THE DRAWINGS

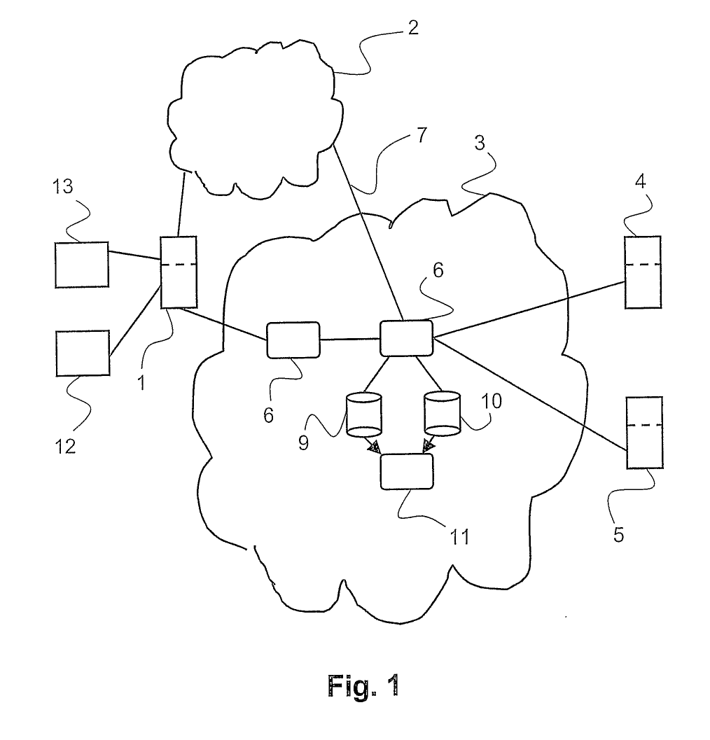

FIG. 1 schematically depicts a network architecture as envisioned in the invention comprising a circuit switched (CS) network 3, a further telecommunications network 2 (for example a packet switched (PS) network) and a plurality of users connected to said circuit switched network via terminals 1, 4 and 5. The CS network 3 comprises at least one or more network nodes 6 wherein at least one of the nodes 6 registers and stores call detail information in a call detail database 9. A user information database 10 is arranged to store user submitted information after a call has been established. A correlator 11 associates call detail information comprised in a call detail record with user submitted data. This may result in the addition to said call detail record of said user information, or alternatively, the information may be kept separately and may then be merged later on for providing a telephone bill.

The present invention provides an improved way of handling calls between a plurality of users via terminals 1, 4, 5 in a telecommunications network 3. The communications network 3 maybe for example a circuit switched telecommunications network.

The communications network comprises at least one or more network nodes 6. When a call is set-up between at least two communication devices 1, 4, 5 at least one of the network nodes 6 registers and stores call related information in a database 9. After a call has been established, information submitted by a user using his/her communication device (let's assume communications device 1 is used for adding the user information) is forwarded to at least one of the network nodes 6 which registers and stores said user information, e.g. in user information database 10. Submitted user information may be transmitted over the circuit switched network 3 or over an additional packet switched network 2 having at least one interconnection 7 with said circuit switched network 3.

The present invention is designed to enable the input of subscriber desired data into a call detail record related to a call, or for association therewith, after the call has been established. This information may be provided by the user during the call, or after the call has been ended (e.g. in case for example a terminal is used comprising a memory of recently established calls). The call can be an incoming or an outgoing call of the subscriber of a telecommunications network 3. The information can be input on the telecommunication terminal 1 in use by the subscriber, e.g. a DTM terminal running an application supporting the sending of user information on the CS network 3 or a PS network 2. The user information can be an account number identifying the project a link to a document or web page, for which the telephone call was made or accepted.

The communication terminal 1 could be connected to the CS part of the communications network. After a call has been established further user information input on the communication terminal is forwarded to at least one of the network nodes 6 which registers and stores said user information. Call detail information related to said established call is associated with said input user information based on identification data for associating said user information with said call detail information.

The communication terminal 1 could also be connected to the CS 3 and the PS communications network 2. After a call has been established on the CS telecommunications network 3, further user information input on the communication terminal 1 is forwarded on the PS communications network 2 to at least one of the network nodes 6 which registers and stores said user information. Call detail information related to said established call is associated with said input user information based on identification data for associating said user information with said call detail information.

The communications terminal could also comprise a private switching device 1, connecting for example a telephone 12 to the CS network 3 and a personal computer 13 to the PS network 2. The personal computer 13 may be running an application that supports the sending of user information to the PS network.

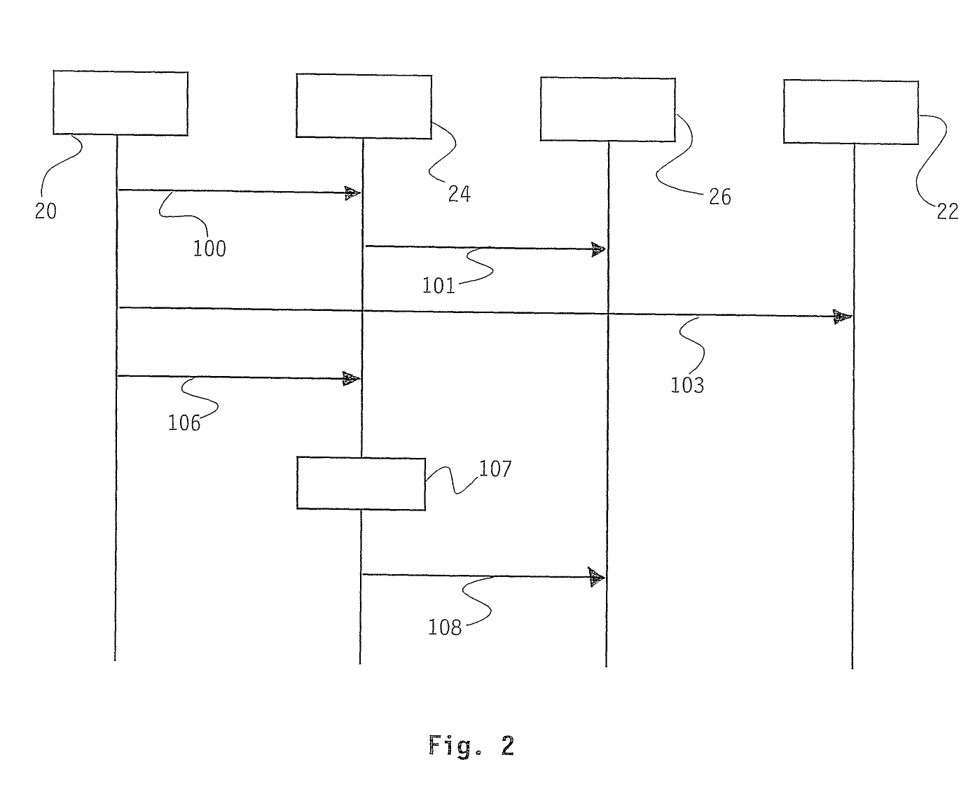

FIG. 2 schematically depicts a sequence of events that may take place in a method of the present invention, where user information is to be added to or associated with a call detail record after a call has been established.

Here, the first column depicts a first user terminal 20 and the fourth column depicts a second user terminal 22. The second and third column in FIG. 2 respectively indicate method steps performed in a network node (e.g. node 6 of FIG. 1) and the CDR database (such as database 9 in FIG. 1). During a CS call-setup (step 100), the CS network node creates CDR output (step 101) for the party (A and/or B) that has the service ‘add-user-info-to-CDR’. This is to make sure that CDR output is generated for the user, even if this party does not pay for this call. This CDR-output contains information that is normally available for CS-calls, such as A-nr, B-nr, start-time/date, end-time/date, tariff.

When the call has been established (step 103) and the A-party (and/or B-party) wants to add user-information to the CDR, it sends a Session Initiation Protocol (SIP) invite message (SIP-INVITE) (step 106) to the service ‘add-user-info-to-CDR’. The INVITE contains enough (A and/or B-party related) information to correlate (step 107) this INVITE (PS) to the ongoing CS-call. The INVITE contains the ‘user-information’ that has to be added to the CDR. This ‘user information’ is sent, via the CS network or PS-network to a network node where said information is stored (step 108). Said information storage could be the user information database (such as database 10 in FIG. 1). As it can be envisioned, many calls will be established and terminated on the telecommunications network and therefore it is necessary that the user information that is input, is correlated to the call to which it pertains. This correlation can be based on for example on the international mobile subscriber identity (IMSI) number and an associated counter that identifies the call.

When said call detail information and said user information correlate, both information are stored in a further call detail record. Periodically said call detail record containing user information and call detail information is output to a so called telephone bill. When the telephone bill is sent to the subscriber, the ‘user information’ is added to the specification of the call.

In one embodiment (not shown) the information is placed as a hyperlink on an on-line telephone bill. If the receiver (or someone else) clicks with a mousebutton on the hyperlink, a webpage of the user associated with the user information may open for example. One may also consider placing a photograph as user information on the telephone bill.

If no correlation can be found or no user information was input after the call has been established, only a call detail record is generated containing call detail information that is output to a so-called telephone bill.

1. A method of handling a call between a plurality of users via a circuit switched telecommunications network, wherein each of said plurality of users comprises a terminal connected to said network for establishing said call, wherein said call between said users is established by at least one of said users providing terminal identification data of a terminal of at least one other of said users, and wherein call detail information for said call is registered on said network, wherein at least one of said users provides user information for said network for associating said user information with said call detail information, characterized in that, said user information for said circuit switched telecommunications network is made available using a further telecommunications network, and said user information comprises further identification data for associating said user information with said call detail information.

2. The method according to claim 1, wherein said further telecommunications network is a packet switched telecommunications network.

3. The method according to any of the previous claims, wherein said user information for said network is provided via said terminal of said at least one user.

4. The method according to claim 3, wherein said terminal of said at least one user is further connected to said further telecommunications network.

5. The method according to claim 4, wherein said terminal is a dual transfer mode (DTM) communication device.

6. The method according to claim 1, wherein said terminal of said at least one user is one of a group comprising a private switching device, a telephone, a computer system and a communications device connected to a local area network.

7. The method according to claim 6, wherein said terminal is a private switching device, said private switching device being further connected to at least one of a group comprising a telephone, a computer system, a local area network.

8. The method according to claim 3, wherein said user information is made available through a signalling channel.

9. The method according to claim 8, wherein said signaling channel is a D-channel of an ISDN connection.

10. The method according to claim 1, wherein said user is connected to said circuit switched telecommunications network via at least one of a group comprising an integrated services digital network (ISDN), a global system for mobile communications (GSM) network, a universal mobile telecommunications system (UMTS) network, a time division multiple access (TDMA) network and a code division multiple access (CDMA) network.

11. The method according to claim 1, wherein said call is established via at least one network node registering said call detail information, and said user information is provided to said network node.

12. The method according to claim 1, wherein said call detail information is stored in a call detail database.

13. The method according to claim 1, wherein said user information is stored in a user information database.

14. The method according to claim 1, wherein said call detail information is comprised in a call detail record, and wherein said user information is added to said call detail record after associating said user information with said call detail information.

15. The method according to claim 1, wherein said identification data comprises at least one of a group comprising data for identifying at least one of said plurality of users, international mobile subscriber identity (IMSI) number and associated counter that identifies the call.

16. The method according to claim 1, wherein said user information associated to said call detail record is used for specifying a telephone bill.

17. The method according to claim 1, wherein said user information comprises at least one of a group comprising a project account number, a hyperlink to a users document, a users database, a web page, a program, a photograph.

18. The method according to claim 1, wherein said user information is provided using at least one protocol selected from a group comprising unstructured supplementary service data (USSD), user-to-user signalling (UUS), session initiation protocol (SIP), short messaging service (SMS), and multimedia messaging service (MMS).

19. A communication terminal device for use with a method according any of the previous claims in a telecommunications system for handling a call between a plurality of users via a circuit switched telecommunications network, comprising means for connecting to said circuit switched telecommunications network, means for establishing said call by providing terminal identification data of at least one further terminal to said network, and means for providing user information for said circuit switched telecommunications network, characterized in that, said communications terminal device comprises means for connecting to a further telecommunications network, and said means for providing user information are arranged for providing said user information through said further network, wherein said user information comprises identification data for associating said user information with call detail information of said call registered on said circuit switched telecommunications network.

20. The communication terminal device according to claim 19, wherein said communication terminal device is a dual transfer mode (DTM) terminal device.
